(19) United States
(12) Patent Application Publication
(10) Pub. No.: US 2005/0223660 A1
(43) Pub. Date: Oct. 13, 2005

(54) Adjustable portable roof work platform

(76) Inventors: Hunt T. Henning SR., Foley, AL (US); Brian Scott Keith, Mtn. Brook, AL (US)

Correspondence Address: BRIAN SCOTT KEITH, 3324 NORTH WOODBRIDGE RD., MTN. BROOK, AL, 35223, US

(21) Appl. No.: 11/146,549

(22) Filed: Jun. 8, 2005

(51) Int. Cl. E04B 7/18; E06B 3/28; E04D 15/00; E04F 21/00; E04G 21/14

(52) U.S. Cl. 52/203; 52/200

(57) ABSTRACT

The Adjustable Portable Roof Work Platform is a new rectangular platform consisting of an upper deck and a longer lower deck constructed of a light-weight yet sturdy material and tubular framework. The decks are hinged together the edge of the platform that comes in contact with the roof which is labeled the forward edge. Tubular male-female sleeves are attached on the inner parts of the side frames of both decks with hinge pins or bolts with spacer washers to provide support and adjust to accommodate varying roof pitches. The bottom surface of the lower deck is completely covered in non-skid material to provide greater surface tension and adhesion on a roof. The forward edge of the lower deck extends beyond the frame and has holes so that the platform can be secured to a roof with screws or nails. The rear edge of the upper deck has a lip extending upward as an option.

### BACKGROUND OF THE INVENTION

1. Field of the Invention

This invention is an improvement to existing knock-down roof platforms that provide a horizontally level work stand for a person on a roof.

2. Description of Prior Art

U.S. Pat. No. 5,249,397, U.S. Pat. No. 5,913,782, and U.S. Pat. No. 6,732,480 pertain to knock-down roof platforms. U.S. Pat. No. 5,249,397 and U.S. Pat. No. 5,913,782 are platforms with adjustable legs on the front of the platform. U.S. Pat. No. 6,732,480 is an improvement to the prior art and is a platform whereas the edge of the platform that comes in contact with the roof is hinged to a lower frame with non-skid feet for greater surface tension and adhesion of the art to a roof. While the most recent art does have improved stability and also accommodates varying roof pitches, continued improvements in surface tension and stability are necessary to further increase the safety of workers on and around roof structures and reduce the potential of injury or death.

### SUMMARY OF THE INVENTION

The new invention described herein has much more surface area in contact with a roof to provide even greater surface tension and stability than the current art. The new invention also allows the user to further secure the platform to a roof with screws or nails.

This new rectangular platform generally consists of an upper deck and a longer lower deck constructed of a light-weight yet sturdy material and tubular framework. The decks are hinged together the edge of the platform that comes in contact with the roof which is labeled the forward edge. Tubular male-female sleeves are attached on the inner parts of the side frames of both decks with hinge pins or bolts with spacer washers to provide support and adjust to accommodate varying roof pitches. The rear edge of the upper deck has a lip extending upward as an option.

The bottom surface of the lower deck is completely covered in non-skid material to provide greater surface tension and adhesion on a roof. The forward edge of the lower deck extends beyond the frame and has holes so that the platform can be secured to a roof with screws or nails.

The above is merely a general summary of the invention. The object of the invention and its features are explained in the detailed description and related drawings. Someone skilled in the art will clearly understand the description and drawings and be able to make and use said platform.

### BRIEF DESCRIPTION OF THE DRAWINGS

FIG. 1 is the schematic view of this new invention, the Adjustable Portable Roof Work Platform, shown on an inclined roof.

FIG. 2 is the side view of this invention from the perspective of 3-3.

FIG. 3 is the side view of a different position with respect to FIG. 2.

FIG. 4 is the side view of this invention in the storage/transport position.

FIG. 5 is the view of the forward edge of the platform illustrating how the decks are hinged together.

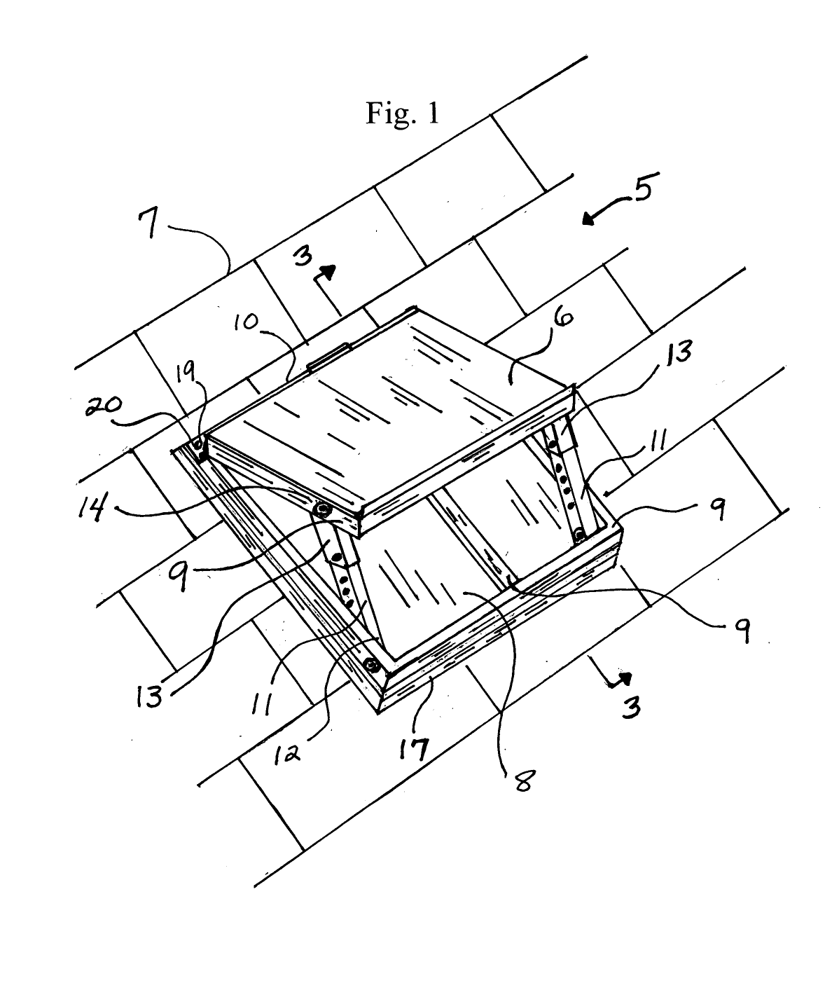

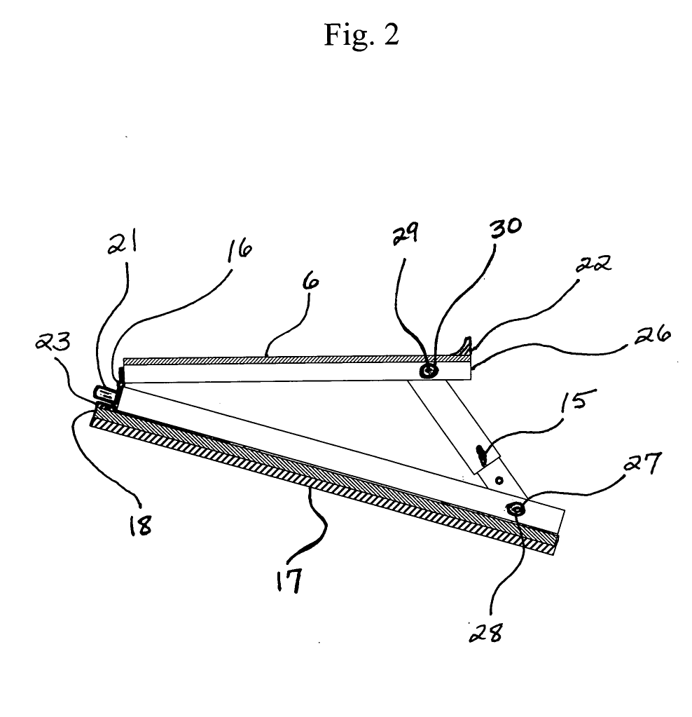

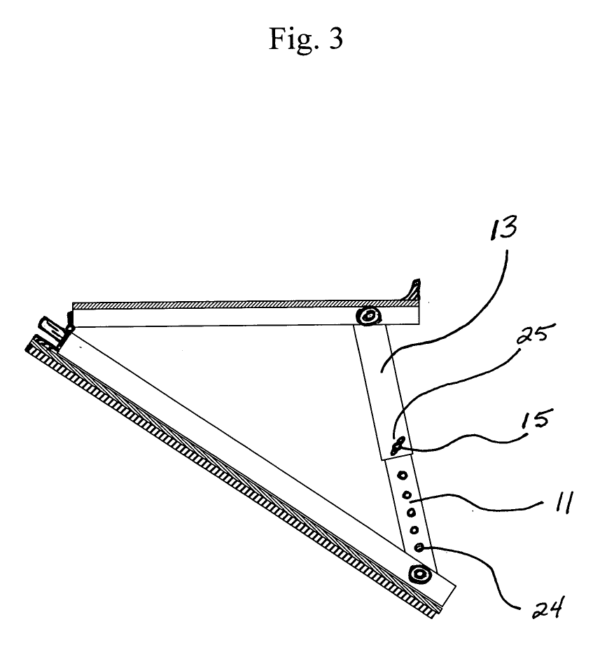

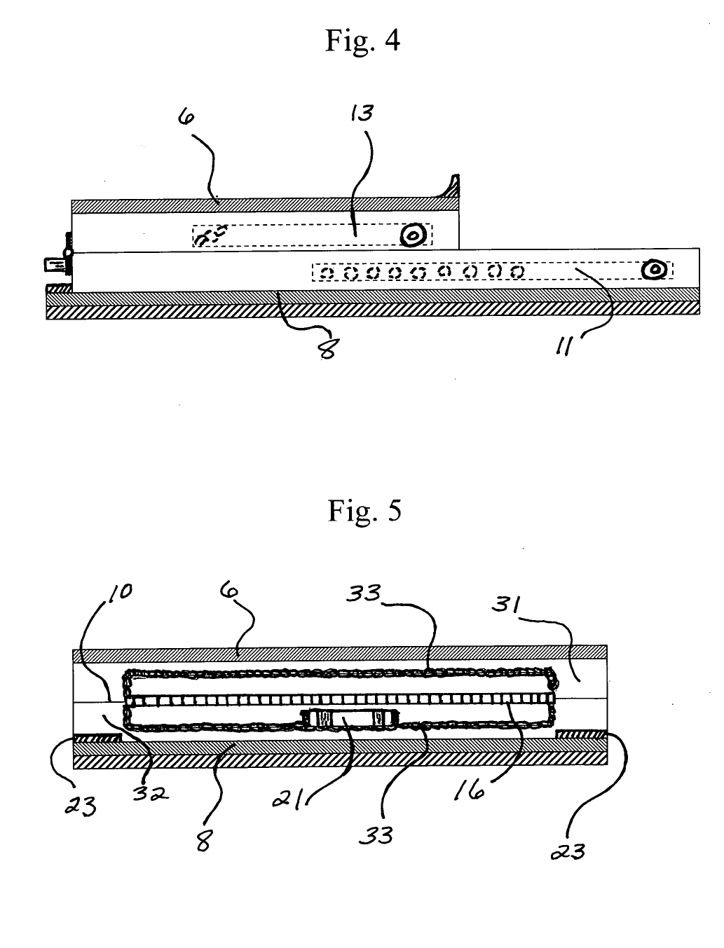

### DESCRIPTION OF THE PREFERRED EMBODIMENT

Reference numeral 5 generally indicates the Adjustable Portable Roof Work Platform. This new rectangular platform 5 consists of an upper deck 6 and a longer, lower deck 8 constructed of a light-weight yet sturdy material and tubular framework 9. The decks are hinged together 16 the edge of the platform that comes in contact with the roof which is labeled the forward edge 10. Tubular male sleeves 11 are attached on the inner parts of the side frames 12 of the lower deck 8 with hinge pins or bolts 27 with spacer washers 28. Tubular female sleeves 13 are attached on the inner parts of the side frames 14 of the upper deck 6 with hinge pins or bolts 29 with spacer washers 30. The male sleeves 11 insert into the female sleeves 13 and are secured via cotter pin or bolt 15 to provide support and adjust to accommodate varying roof pitches.

The forward edge 18 of the lower deck 8 extends beyond the frame and has holes 19 at each corner so that the platform can be secured to a roof 7 with screws or nails 20. The corners are reinforced with a heavier grade material 23. The bottom surface of the lower deck 8 is completely covered in non-skid material 17 to provide greater surface tension and adhesion on a roof 7. The forward edge 10 of the lower deck 8 also has an attached handle 21 for portability purposes. The rear edge 26 of the upper deck 6 has a lip 22 extending upward as an option.

The male sleeves 11 each have sets of aligned holes 24 while the female sleeves 13 have single holes 25. Selecting a particular set of male sleeve holes 24 and securing via cotter pin or bolt 15 with the holes of the female sleeves 13 accommodates varying roof pitches. The hinge 16 is welded 33 or similarly secured to the frame 31 of the upper deck 6 and the frame 32 of the lower deck 8 on forward edge 10 of the platform 5. In addition to allowing varying positions of the platform 5 for different roof pitches, the hinge 16 also allows the platform 5 to collapse for transport and/or storage. The male sleeves 11 fold down into the frame of the lower deck 8 and the female sleeves 13 fold up into the frame of the upper deck 6.

The descriptions above and accompanying drawings are merely general verbal and pictorial illustrations of the principles of this invention and do not limit the construction and use of this invention. Those skilled in the art will have various modifications and these modifications fall within the scope of the Adjustable Portable Roof Work Platform.

1. The new invention, the Adjustable Portable Roof Work Platform, generally consists of an upper deck and a longer lower deck constructed of a light-weight yet sturdy material and tubular framework. The decks are hinged together the edge of the platform that comes in contact with the roof which is labeled the forward edge. Tubular male-female sleeves are attached with hinge pins or bolts on the inner parts of the side frames of both decks to provide support and adjust to accommodate varying roof pitches. The bottom surface of the lower deck is completely covered in non-skid material to provide greater surface tension and adhesion on a roof. The front edge of the lower deck extends beyond the frame and has holes so that the platform can be secured to a roof with screws or nails.

2. The rear edge of the upper deck of the platform in claim 1 has a lip extending upward as an option.

3. The platform in claim 1 collapses for transport and/or storage. The male sleeves fold down into the frame of the lower deck and the female sleeves fold up into the frame of the upper deck.

4. The front edge of the lower deck the platform in claim 1 also has an attached handle for portability purposes.
